(19) United States
(12) Patent Application Publication
(10) Pub. No.: US 2021/0370964 A1
(43) Pub. Date: Dec. 2, 2021

(54) INFORMATION PROCESSING DEVICE, NON-TRANSITORY STORAGE MEDIUM, AND INFORMATION PROCESSING METHOD

(71) Applicant: TOYOTA JIDOSHA KABUSHIKI KAISHA, Toyota-shi (JP)

(72) Inventors: Naoki UENOYAMA, Nagoya-shi (JP); Josuke YAMANE, Nisshin-shi (JP); Takumi FUKUNAGA, Nisshin-shi (JP); Hikaru GOTOH, Nagoya-shi (JP); Soutaro KANEKO, Nagoya-shi (JP)

(73) Assignee: TOYOTA JIDOSHA KABUSHIKI KAISHA, Toyota-shi (JP)

(21) Appl. No.: 17/330,966

(22) Filed: May 26, 2021

(30) Foreign Application Priority Data
May 29, 2020 (JP) 2020-094273

(51) Int. Cl. B60W 50/14; B60W 40/08; G06K 9/00; H04W 4/40; H04W 4/80

(52) U.S. Cl. CPC B60W 50/14; B60W 40/08; G06K 9/00818; G06K 9/00845; B60W 2050/146; H04W 4/80; B60W 2540/225; B60W 2554/80; H04W 4/40

(57) ABSTRACT

An object of the present disclosure is to provide a technology for preventing a smooth flow of traffic from being hindered by a vehicle that is unnecessarily stopped on a road. An information processing device detects that display of a traffic light is switched from a first signal instructing a vehicle to stop to a second signal allowing the vehicle to proceed. When the display of the traffic light is switched from the first signal to the second signal, the information processing device transmits a first command to a mobile terminal carried by a driver of a first vehicle that is stopped before the traffic light, the first command instructing that a first notification for urging the driver to start moving the first vehicle be output.

### CROSS REFERENCE TO THE RELATED APPLICATION

This application claims the benefit of Japanese Patent Application No. 2020-094273, filed on May 29, 2020, which is hereby incorporated by reference herein in its entirety.

### BACKGROUND

### Technical Field

The present disclosure relates to an information processing device and an information processing method for transmitting information to a mobile terminal that is carried by a driver of a vehicle, and a program for controlling the mobile terminal.

### Description of the Related Art

Japanese Patent Laid-Open No. 2019-26211 discloses a technology related to a system for monitoring operation of a smartphone by a driver of a vehicle. With the system disclosed in Japanese Patent Laid-Open No. 2019-26211, operation information is transmitted from the smartphone to a monitoring server or an on-board unit. The monitoring server or the on-board unit detects, based on the operation information transmitted from the smartphone, a user operation on the smartphone performed during driving, creates an alarm event, and transmits the same to the smartphone. The smartphone outputs an alarm for the driver according to the received alarm event.

### CITATION LIST

### Patent document

[Patent document 1] Japanese Patent Laid-Open No. 2019-26211

### SUMMARY

An object of the present disclosure is to provide a technology for preventing a smooth flow of traffic from being hindered by a vehicle that is unnecessarily stopped on a road.

An information processing device according to a first mode of the present disclosure includes a controller configured to:

detect that display of a traffic light is switched from a first signal instructing a vehicle to stop to a second signal allowing the vehicle to proceed, and

transmit a first command to a mobile terminal carried by a driver of a first vehicle that is stopped before the traffic light, when the display of the traffic light is switched from the first signal to the second signal, the first command instructing that a first notification for urging the driver to start moving the first vehicle be output.

A non-transitory storage medium according to a second mode of the present disclosure is a non-transitory storage medium storing a program that is executed by a computer that controls a mobile terminal, where the program causes the mobile terminal to:

receive a first command from an information processing device that, when display of a traffic light is switched from a first signal instructing a vehicle to stop to a second signal allowing the vehicle to proceed, transmits the first command to the mobile terminal carried by a driver of a first vehicle that is stopped before the traffic light, the first command instructing that a first notification for urging the driver to start moving the first vehicle be output, and

output the first notification when the first command is received.

An information processing method according to a third mode of the present disclosure is an information processing method that is performed by a computer, the method including:

detecting that display of a traffic light is switched from a first signal instructing a vehicle to stop to a second signal allowing the vehicle to proceed; and

transmitting a first command to a mobile terminal carried by a driver of a first vehicle that is stopped before the traffic light, when the display of the traffic light is switched from the first signal to the second signal, the first command instructing that a first notification for urging the driver to start moving the first vehicle be output.

According to the present disclosure, a smooth flow of traffic may be prevented from being hindered by a vehicle that is unnecessarily stopped on a road.

### BRIEF DESCRIPTION OF THE DRAWINGS

FIG. 1 is a diagram illustrating a schematic configuration of a monitoring system according to a first embodiment;

FIG. 2 is a diagram for describing an example of traveling states, before a traffic light, of vehicles that are monitoring targets of the monitoring system;

FIG. 3 is a diagram illustrating an example of a first notification that is output at a mobile terminal;

FIG. 4 is a block diagram according to the first embodiment, schematically illustrating an example of a functional configuration of each of an on-board device and the mobile terminal;

FIG. 5 is a flowchart according to the first embodiment, illustrating a flow of information processing that is performed by a controller of the on-board device;

FIG. 6 is a flowchart according to the first embodiment, illustrating a flow of information processing that is performed by a controller of the mobile terminal;

FIG. 7 is a flowchart according to an example modification 3 of the first embodiment, illustrating a flow of information processing that is performed by the controller of the mobile terminal;

FIG. 8 is a flowchart according to a second embodiment, illustrating a flow of information processing that is performed by the controller of the on-board device;

FIG. 9 is a diagram illustrating an example of a second notification that is output at the mobile terminal;

FIG. 10 is a flowchart according to a third embodiment, illustrating a flow of information processing that is performed by the controller of the on-board device;

FIG. 11 is a flowchart according to the third embodiment, illustrating a flow of information processing that is performed by the controller of the mobile terminal;

FIG. 12 is a flowchart according to an example modification of the third embodiment, illustrating a flow of information processing that is performed by the controller of the mobile terminal;

FIG. 13 is a diagram illustrating a schematic configuration of a monitoring system according to a fourth embodiment; and

FIG. 14 is a block diagram according to the fourth embodiment, schematically illustrating an example of a functional configuration of a management server.

### DESCRIPTION OF THE EMBODIMENTS

With an information processing device according to a first mode of the present disclosure, a controller may detect that display of a traffic light is switched from a first signal to a second signal. The first signal of a traffic signal is a signal instructing a vehicle to stop. The second signal of the traffic signal is a signal allowing the vehicle to proceed. As the first signal, a red signal may be cited as an example. As the second signal, a green signal may be cited as an example.

A vehicle that is stopped before a traffic light when the traffic light is displaying the first signal is taken as a first vehicle. At this time, the controller of the information processing device may transmit a first command to a mobile terminal carried by a driver of the first vehicle, when display of the traffic light is switched from the first signal to the second signal. The first command is information for instructing the mobile terminal to output a first notification for urging the driver to start moving the first vehicle.

A situation is conceivable where the driver of the first vehicle operates or looks at the mobile terminal that he/she is carrying, when the first vehicle is stopped before the traffic light displaying the first signal. At this time, the driver of the first vehicle sometimes does not notice that the display of the traffic light is switched from the first signal to the second signal when the display of the traffic light is switched. In this case, the first vehicle remains stopped even though the traffic light is displaying the second signal, and the first vehicle possibly hinders a smooth flow of traffic.

With the information processing device according to the first mode of the present disclosure, as described above, the first command is transmitted to the mobile terminal carried by the driver of the first vehicle when the display of the traffic light is switched from the first signal to the second signal. The first notification is output at the mobile terminal as a result. Accordingly, even if the driver of the first vehicle is operating or looking at the mobile terminal, the driver is urged by the first notification output by the mobile terminal to start moving the first vehicle. This may prevent the first vehicle from remaining stopped before the traffic light even though the traffic light is displaying the second signal. Accordingly, a smooth flow of traffic may be prevented from being hindered by the vehicle that is unnecessarily stopped on a road.

Hereinafter, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

(Outline of System)

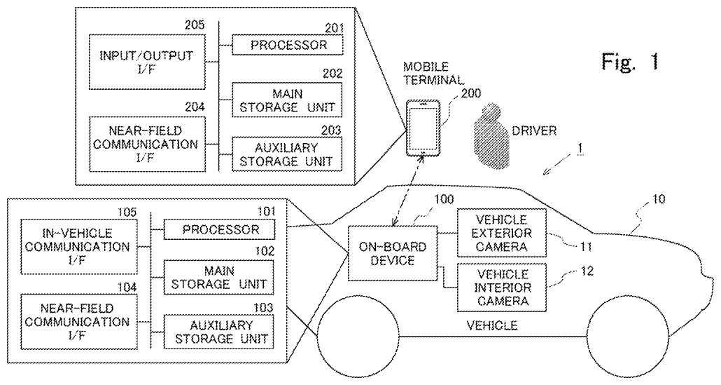

An embodiment will be described for a case where an information processing device, a program, and an information processing method according to the present disclosure are applied to a monitoring system that monitors a traveling state of a vehicle. FIG. 1 is a diagram illustrating a schematic configuration of the monitoring system according to the present embodiment. A monitoring system 1 includes an on-board device 100, a vehicle exterior camera 11 and a vehicle interior camera 12 that are mounted on a vehicle 10, and a mobile terminal 200 that is carried by a driver of the vehicle 10. In the monitoring system 1, communication is performed between the on-board device 100 and the mobile terminal 200 through near-field wireless communication.

The vehicle exterior camera 11 is a camera that captures a surrounding state of the vehicle 10. For example, in a case where a traffic light, another vehicle or the like is present ahead of the vehicle 10, an image including the same is captured by the vehicle exterior camera 11. Moreover, the vehicle interior camera 12 is a camera that captures a state of a vehicle interior of the vehicle 10. For example, a driver seated in a driver's seat of the vehicle 10 is captured by the vehicle interior camera 12. In the vehicle 10, the vehicle exterior camera 11 and the vehicle interior camera 12 are connected to the on-board device 100 over a predetermined in-vehicle network. Images captured by the vehicle exterior camera 11 and the vehicle interior camera 12 are transmitted to the on-board device 100.

The on-board device 100 includes a computer that can be mounted on the vehicle 10. The computer configuring the on-board device 100 includes a processor 101, a main storage unit 102, an auxiliary storage unit 103, a near-field communication interface (a near-field communication I/F) 104, and an in-vehicle communication interface (an in-vehicle communication I/F) 105.

The processor 101 here is a central processing unit (CPU) or a digital signal processor (DSP), for example. The main storage unit 102 is a random access memory (RAM), for example. The auxiliary storage unit 203 is a read only memory (ROM), a hard disk drive (HDD), or a flash memory, for example. The auxiliary storage unit 103 may further include a removable medium (a removable recording medium). The removable medium here is a USB memory, an SD card, or a disk recording medium such as a CD-ROM, a DVD disc or a Blu-ray disc.

The near-field communication I/F 104 is an interface used by the on-board device 100 to directly communicate with the mobile terminal 200 using a predetermined near-field wireless communication standard. Examples of the predetermined near-field wireless communication standard include the Bluetooth (registered trademark) Low Energy standard and WiFi (registered trademark). The in-vehicle communication I/F 105 is an interface that is used by the on-board device 100 to communicate with the vehicle exterior camera 11 and the vehicle interior camera 12 over the predetermined in-vehicle network.

With the on-board device 100 configured in the above manner, the auxiliary storage unit 103 stores an operating system (OS), various programs, various information tables and the like. A process for monitoring a traveling state of a vehicle as described below is performed by the processor 101 loading programs stored in the auxiliary storage unit 203 into the main storage unit 102 and executing the same. However, one or some or all of functions of the on-board device 100 may be implemented by a hardware circuit such as an ASIC or an FPGA. Additionally, the on-board device 100 does not necessarily have to be implemented by a single physical configuration, and may alternatively be implemented by a plurality of computers that coordinate with each other.

The mobile terminal 200 includes a computer including a processor 201, a main storage unit 202, an auxiliary storage unit 203, a near-field communication interface (a near-field communication I/F) 204, and an input/output interface (an input/output I/F) 205. Examples of the mobile terminal 200 include a smartphone and a tablet computer. As specific examples of the processor 201, the main storage unit 202, the auxiliary storage unit 203, and the near-field communication I/F 204, those that are the same as specific examples of the processor 101, the main storage unit 102, the auxiliary storage unit 103, and the near-field communication I/F 104 of the above-described computer configuring the on-board device 100 may be cited. The input/output I/F 205 is an interface that is used to receive an input operation from a driver of the vehicle 10 and to output information for the driver. For example, the input/output I/F 205 includes a camera and a touch panel display. At the mobile terminal 200, a predetermined application for using the monitoring system 1 is executed.

(Traveling State of Vehicle)

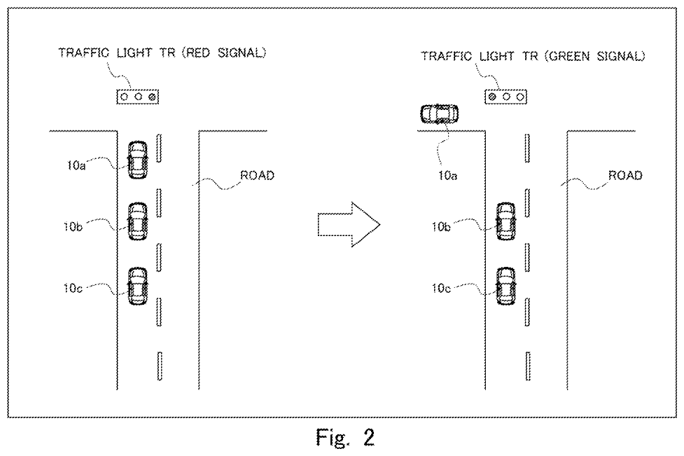

FIG. 2 is a diagram for describing an example of traveling states, before a traffic light, of vehicles that are monitoring targets of the monitoring system 1. On the left in FIG. 2, a state is illustrated where three vehicles 10a, 10b, 10c are stopped in the presented order before a traffic light TR, where display of the traffic light TR is the red signal (a signal instructing vehicles to stop). On the right in FIG. 2, states of the three vehicles 10a, 10b, 10c after the display of the traffic light TR is switched to the green signal (a signal allowing vehicles to proceed) are illustrated.

Normally, when the display of the traffic light TR is switched from the red signal to the green signal, the driver of a vehicle 10 that is stopped before the traffic light TR starts the vehicle 10 and resumes traveling. However, if the driver of the vehicle 10 is operating or looking at the mobile terminal 200 that the driver is carrying, when the display of the traffic light TR is switched from the red signal to the green signal, the driver possibly does not notice that the display of the traffic light TR is switched. It is assumed that, in FIG. 2, the driver of the vehicle 10b does not notice that the display of the traffic light TR is switched, because he/she is operating or looking at the mobile terminal 200. In this case, as illustrated in FIG. 2, another vehicle 10a that is stopped ahead of the vehicle 10b starts to move when the display of the traffic light TR is turned to the green signal, but the vehicle 10b remains stopped before the traffic light TR. Another vehicle 10C that is stopped behind the vehicle 10b is thus prevented from moving. That is, a smooth flow of traffic is hindered because the vehicle 10b is unnecessarily stopped on the road.

Accordingly, with the monitoring system 1, when a vehicle 10 is stopped before a traffic light TR, the on-board device 100 detects that the display of the traffic light TR is switched from the red signal to the green signal, based on an image received from the vehicle exterior camera 11. Furthermore, when the display of the traffic light TR is switched from the red signal to the green signal, the on-board device 100 determines whether the driver of the vehicle 10 is operating or looking at the mobile terminal 200, based on an image received from the vehicle interior camera 12. Then, in the case where it is determined that the driver of the vehicle 10 is operating or looking at the mobile terminal 200, a first command is transmitted from the on-board device 100 to the mobile terminal 200. The first command here is a command instructing that a first notification for urging the driver to start moving the vehicle 10 be output.

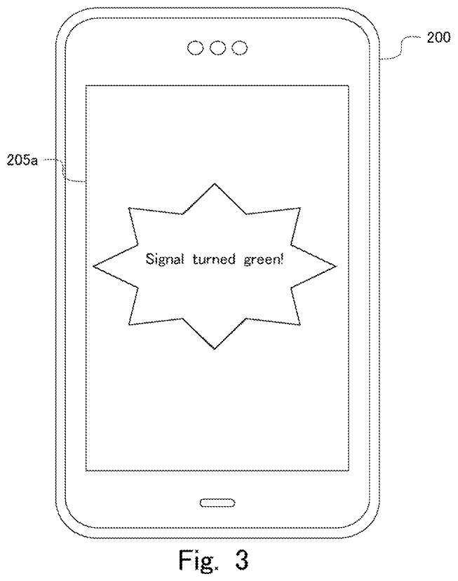

When the first command is transmitted from the on-board device 100 to the mobile terminal 200, the first notification is output at the mobile terminal 200 that the driver of the vehicle 10 is operating or looking at. FIG. 3 is a diagram illustrating an example of the first notification that is output at the mobile terminal 200. In FIG. 3, a message “Signal turned green!” is displayed as the first notification, on a touch panel display 205a included in the input/output I/F 205 of the mobile terminal 200. Additionally, the first notification may be a mark for notifying that the display of the traffic light TR is the green signal, for example. Moreover, the first notification is displayed preferentially to an image on the mobile terminal 200 that the driver of the vehicle 10 is operating or looking at.

When the first notification is output at the mobile terminal 200 in the manner described above, the driver who is operating or looking at the mobile terminal 200 may be made to notice that the display of the traffic light TR is the green signal. As a result, the stopped vehicle 10 may be urged to start moving. Accordingly, occurrence of a state where the vehicle 10 is stopped before the traffic light TR even though the display of the traffic light TR is the green signal may be prevented. A smooth flow of traffic may thus be prevented from being hindered by the vehicle 10 that is unnecessarily stopped on the road.

(Functional Configuration)

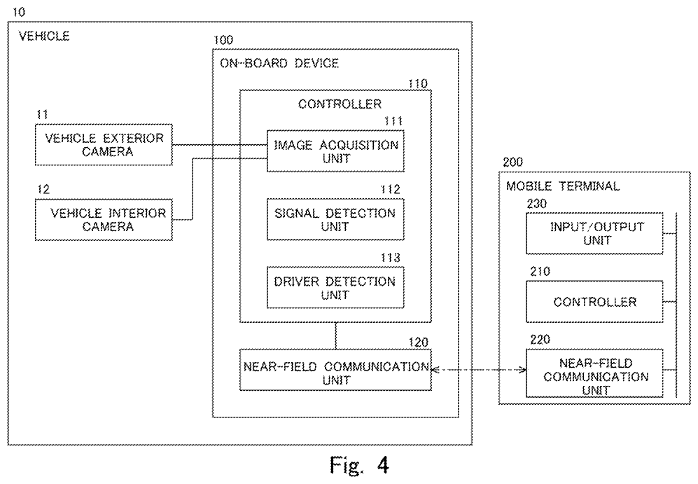

Next, a functional configuration of each of the on-board device 100 and the mobile terminal 200 of the monitoring system 1 according to the present embodiment will be described with reference to FIG. 4. FIG. 4 is a block diagram schematically illustrating an example of the functional configuration of each of the on-board device 100 and the mobile terminal 200.

(On-Board Device)

The on-board device 100 mounted on the vehicle 10 includes a controller 110 and a near-field communication unit 120. The controller 110 includes a function of performing arithmetic processing to control the on-board device 100. The controller 110 may be implemented by the processor 101.

The controller 110 includes an image acquisition unit 111, a signal detection unit 112, and a driver detection unit 113. The image acquisition unit 111 includes a function of acquiring images that are transmitted from the vehicle exterior camera 11 and the vehicle interior camera 12 over the in-vehicle network. The signal detection unit 112 includes a function of detecting a traffic light existing ahead of the vehicle 10, by performing predetermined image processing on an image from the vehicle exterior camera 11 that is acquired by the image acquisition unit 111. The signal detection unit 112 further determines the signal that is being displayed by the traffic light that is detected. The driver detection unit 113 includes a function of detecting the driver of the vehicle 10, by performing predetermined image processing on an image from the vehicle interior camera 12 that is acquired by the image acquisition unit 111. The driver detection unit 113 further determines whether the driver of the vehicle 10 who is detected is operating or looking at the mobile terminal 200 that the driver is carrying.

The near-field communication unit 120 includes a function of performing communication with the mobile terminal 200 inside the vehicle 10, through near-field wireless communication. The near-field communication unit 120 may be implemented by the near-field communication I/F 104. The controller 110 performs a process of transmitting the first command to the mobile terminal 200 by using the near-field communication unit 120.

(Mobile Terminal)

The mobile terminal 200 includes a controller 210, a near-field communication unit 220, and an input/output unit 230. The controller 210 includes a function of performing arithmetic processing to control the mobile terminal 200. The controller 210 may be implemented by the processor.

The near-field communication unit 220 includes a function of performing communication with the on-board device 100 through near-field wireless communication when the mobile terminal 200 is inside the vehicle 10. The near-field communication unit 220 may be implemented by the near-field communication I/F 204. The controller 210 performs a process of receiving the first command that is transmitted from the on-board device 100, by using the near-field communication unit 220.

The input/output unit 230 includes a function of receiving input of information, and a function of outputting information. The input/output unit 230 may be implemented by the input/output I/F 205. The controller 210 performs, using the input/output unit 230, a process of receiving input of information by operation by the driver of the vehicle 10, and a process of providing information to the driver. Furthermore, in the case where the first command is received from the on-board device 100, the controller 210 performs, using the input/output unit 230, a process of outputting the first notification as illustrated in FIG. 3.

(Flow of Information Processing)

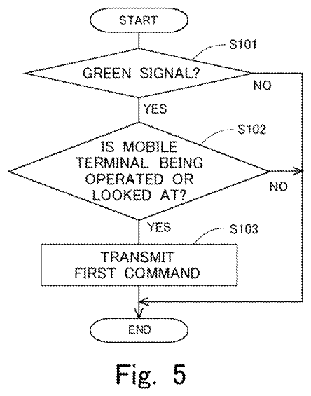

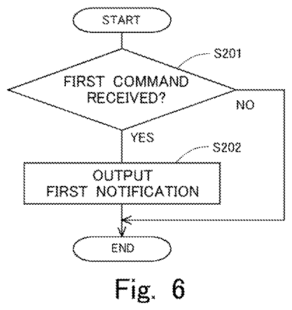

In the following, a flow of information processing that is performed by each of the on-board device 100 and the mobile terminal 200 of the monitoring system 1 according to the present embodiment will be described with reference to FIGS. 5 and 6. FIG. 5 is a flowchart illustrating a flow of information processing that is performed by the controller 110 of the on-board device 100. FIG. 6 is a flowchart illustrating a flow of information processing that is performed by the controller 210 of the mobile terminal 200 inside the vehicle 10.

Additionally, the processes illustrated in FIGS. 5 and 6 are repeatedly performed when the vehicle 10 is stopped before a traffic light. For this purpose, that the vehicle 10 is stopped before a traffic light may be detected by the on-board device 100. As described above, the on-board device 100 may detect presence of a traffic light ahead of the vehicle 10 based on an image from the vehicle exterior camera 11. Furthermore, the on-board device 100 may detect that the vehicle 10 is stopped, based on a state of a brake pedal of the vehicle 10, for example. Furthermore, the on-board device 100 may acquire map information including position information of a traffic light, and position information of the vehicle 10, and may detect that the vehicle 10 is stopped before a traffic light, based on these information pieces. The mobile terminal 200 may repeat the processes illustrated in FIG. 6 while the predetermined application for using the monitoring system 1 is active.

In the flow illustrated in FIG. 5, first, in S101, whether the display of a traffic light existing ahead of the vehicle 10 is switched from the red signal to the green signal is determined based on an image that is acquired from the vehicle exterior camera 11. If the traffic light is displaying the red signal, a negative determination is made in S101. In this case, execution of the present flow is temporarily ended. In the case where a positive determination is made in S101, or in other words, in the case where it is detected that the display of the traffic light existing ahead of the vehicle 10 is switched from the red signal to the green signal, the process in S102 is performed next.

In S102, whether the driver of the vehicle 10 is operating or looking at the mobile terminal 200 that the driver is carrying, based on an image that is acquired from the vehicle interior camera 12. If the driver of the vehicle 10 is not operating or looking at the mobile terminal 200, a negative determination is made in S102. In this case, execution of the present flow is temporarily ended. That is, in this case, the first command is not transmitted to the mobile terminal 200. In the case where a positive determination is made in S102, or in other words, in the case where the driver of the vehicle 10 is operating or looking at the mobile terminal 200, the process in S103 is performed next. In S103, the first command is transmitted to the mobile terminal 200 using the near-field communication unit 120.

In the flow illustrated in FIG. 6, first, in S201, whether the first command is received by the near-field communication unit 220 from the on-board device 100 is determined. If the first command is not transmitted by the on-board device 100, the first command is not received by the mobile terminal 200, and a negative determination is made in S201. If the first command is transmitted by the on-board device 100, the first command is received by the mobile terminal 200. In this case, a positive determination is made in S201, and the process in S202 is performed next. In S202, the first notification is output using the input/output unit 230. The driver who is operating or looking at the mobile terminal 200 may thus be urged to start moving the vehicle 10.

### Example Modification 1

Additionally, the monitoring system 1 may allow the on-board device 100 of the vehicle 10 and a traffic light existing ahead of the vehicle 10 to perform communication. In this case, display information indicating the signal that is being displayed by the traffic light may be transmitted from the traffic light to the on-board device 100. The on-board device 100 may thus determine whether the display of the traffic light is switched from the red signal to the green signal, based on the display information that is received from the traffic light, instead of an image that is acquired from the vehicle exterior camera 11.

### Example Modification 2

Furthermore, with the mobile terminal 200, whether the driver of the vehicle 10 is operating the mobile terminal 200 may be detected by the touch panel display 205a included in the input/output I/F 205. Moreover, with the mobile terminal 200, whether the driver of the vehicle 10 is looking at the mobile terminal 200 may be detected based on an image that is captured by the camera included in the input/output I/F 205. Accordingly, in the monitoring system 1, terminal information indicating that the mobile terminal 200 is being operated or is being looked at may be transmitted from the mobile terminal 200 inside the vehicle 10 to the on-board device 100. The on-board device 100 may thus determine whether the driver of the vehicle 10 is operating or looking at the mobile terminal 200, based on the terminal information that is received from the mobile terminal 200, instead of an image that is acquired from the vehicle interior camera 12.

### Example Modification 3

Moreover, with the monitoring system 1, that the driver of the vehicle 10 is operating or looking at the mobile terminal 200 does not necessarily have to be detected by the on-board device 100. That is, when switching of the display of the traffic light existing ahead of the vehicle 10 from the red signal to the green signal is detected, the on-board device 100 may transmit the first command to the mobile terminal 200 without determining whether the driver of the vehicle 10 is operating or looking at the mobile terminal 200. Additionally, the flow of information processing that is performed by the controller 110 of the on-board device 100 at this time is the flow illustrated in FIG. 5 without S102.

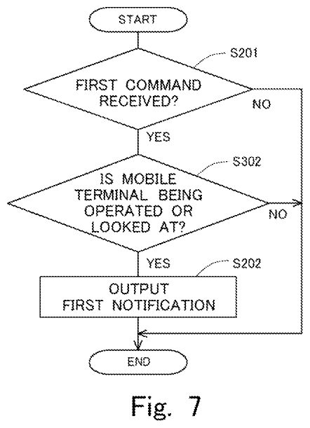

In the present example modification, the mobile terminal 200 may determine whether the driver of the vehicle 10 is operating or looking at the mobile terminal 200, when the first command is received. A flow of information processing that is performed by the mobile terminal 200 in the present example modification will be described with reference to FIG. 7. FIG. 7 is a flowchart illustrating a flow of information processing that is performed by the controller 210 of the mobile terminal 200 inside the vehicle 10. Additionally, processes performed in S201 and S202 in the flow illustrated in FIG. 7 are the same as the processes performed in S201 and S202 in the flow illustrated in FIG. 6, and a description thereof will be omitted.

In the flow illustrated in FIG. 7, in the case where a positive determination is made in S201, the process in S302 is performed next. In S302, whether the driver of the vehicle 10 is operating or looking at the mobile terminal 200 is determined. Then, if the driver of the vehicle 10 is not operating or looking at the mobile terminal 200, a negative determination is made in S302. In this case, execution of the present flow is temporarily ended. That is, the first notification is not output at the mobile terminal 200. In the case where a positive determination is made in S302, or in other words, in the case where the driver of the vehicle 10 is operating or looking at the mobile terminal 200, the process in S202 is performed next.

Also with the flow as described above, if the driver of the vehicle 10 that is stopped before a traffic light is operating or looking at the mobile terminal 200 when the display of the traffic light is switched from the red signal to the green signal, the first notification is output at the mobile terminal 200.

### Second Embodiment

A present embodiment is different from the first embodiment in that the on-board device 100 in the monitoring system 1 detects, when the vehicle 10 is stopped before a traffic light, another vehicle that is stopped before the traffic light and ahead of the subject vehicle 10. In the following, only the differences from the first embodiment will be described.

In the case where another vehicle is stopped ahead of the subject vehicle 10 before a traffic light, the driver cannot start moving the subject vehicle 10 even when the display of the traffic light is switched from the red signal to the green signal, if such other vehicle does not start moving (for example, in the case where the vehicle 10c in FIG. 2 is the subject vehicle, the vehicle 10c cannot start moving even when the display of the traffic light TR is switched from the red signal to the green signal, if the other vehicle 10b ahead of the vehicle 10c does not start moving). Accordingly, in the present embodiment, the controller 110 of the on-board device 100 detects not only the traffic light that is present ahead of the subject vehicle 10, but also another vehicle that is present before the traffic light and ahead of the subject vehicle 10, by performing predetermined image processing on an image from the vehicle exterior camera 11 that is acquired by the image acquisition unit 111. Then, in the case where another vehicle that is present ahead of the subject vehicle 10 is stopped, the on-board device 100 transmits the first command to the mobile terminal 200 after the display of the traffic light is switched from the red signal to the green signal and such other vehicle starts moving.

(Flow of Information Processing)

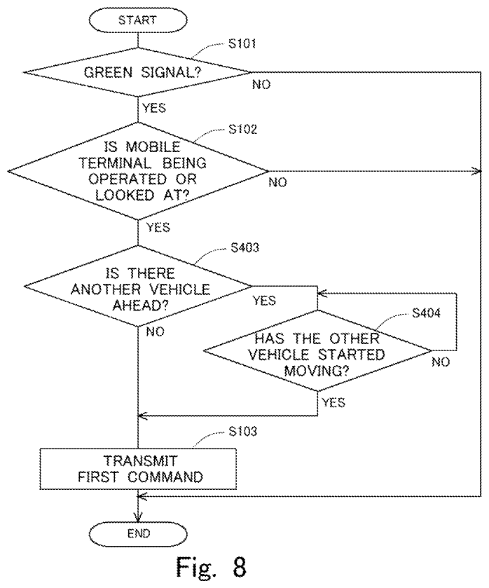

In the following, a flow of information processing that is performed by the on-board device 100 in the monitoring system 1 according to the present embodiment will be described with reference to FIG. 8. FIG. 8 is a flowchart illustrating a flow of information processing that is performed by the controller 110 of the on-board device 100. Additionally, processes performed in steps S101 to S103 in the flow illustrated in FIG. 8 are the same as the processes performed in steps S101 to S103 in the flow illustrated in FIG. 5, and a description thereof will be omitted. Furthermore, also in the present embodiment, the same information processing as that in the first embodiment is performed by the mobile terminal 200.

In the flow illustrated in FIG. 8, in the case where a positive determination is made in S102, the process in S403 is performed next. In S403, whether there is another vehicle before the traffic light and ahead of the subject vehicle 10 is determined based on an image that is acquired from the vehicle exterior camera 11. If there is no other vehicle, a negative determination is made in S403, and the process in S103 is performed next.

In the case where a positive determination is made in S403, or in other words, in the case where another vehicle that is present before the traffic light and ahead of the subject vehicle 10 is detected, the process in S404 is performed next. In S404, whether the other vehicle that is detected in S403 is moving is determined. Additionally, whether the other vehicle that is detected in S403 is moving may be determined based on whether the other vehicle moved forward in an image that is acquired from the vehicle exterior camera 11. In the case where a negative determination is made in S404, or in other words, in the case where the other vehicle that is detected in S403 is stopped, the process in S404 is performed again. In the case where a positive determination is made in S404, or in other words, in the case where the other vehicle that is detected in S403 is moving, the process in S103 is performed next.

According to the flow as described above, in the case where another vehicle is stopped before a traffic light and ahead of the subject vehicle 10, the first command is transmitted from the on-board device 100 to the mobile terminal 200 after the other vehicle starts moving. Accordingly, the driver who is operating or looking at the mobile terminal 200 may be urged to start moving the subject vehicle 10, after the other vehicle that is stopped ahead of the subject vehicle 10 starts moving.

Additionally, the example modifications 1 to 3 of the first embodiment are applicable to the present embodiment.

### Third Embodiment

Also in a present embodiment, when the vehicle 10 is stopped before a traffic light, the monitoring system 1 performs the same processes as those in the first embodiment or the second embodiment. In the following, a description will be given of a process that is performed by the monitoring system 1 after the vehicle 10 that is stopped before a traffic light starts moving due to switching of the display of the traffic light from the red signal to the green signal.

When a vehicle 10 that is stopped before a traffic light starts moving due to switching of the display of the traffic light from the red signal to the green signal, a traveling speed of the vehicle 10 stays relatively low for a while, and the driver of the vehicle 10 possibly operates or looks at the mobile terminal 200 that the driver is carrying. At this time, if there is another vehicle ahead of the subject vehicle 10, and such other vehicle is stopped or a traveling speed of such other vehicle is lower than the traveling speed of the subject vehicle 10, the subject vehicle 10 possibly comes very close to such other vehicle. However, if the driver of the subject vehicle 10 is operating or looking at the mobile terminal 200, the driver possibly does not notice that the subject vehicle 10 is moving close to such other vehicle existing ahead.

Accordingly, with the monitoring system 1 according to the present embodiment, after the subject vehicle 10 starts moving due to switching of the display of the traffic light from the red signal to the green signal, the on-board device 100 determines whether a distance between another vehicle existing ahead of the subject vehicle 10 and the subject vehicle 10 is equal to or smaller than a predetermined distance. Furthermore, in the case where the distance between such other vehicle and the subject vehicle 10 reaches or falls below the predetermined distance, the on-board device 100 determines whether the driver of the subject vehicle 10 is operating or looking at the mobile terminal 200. Then, in the case where the driver of the vehicle 10 is determined to be operating or looking at the mobile terminal 200, a second command is transmitted from the on-board device 100 to the mobile terminal 200. The second command here is a command instructing that a second notification for urging the driver to stop the vehicle 10 be output.

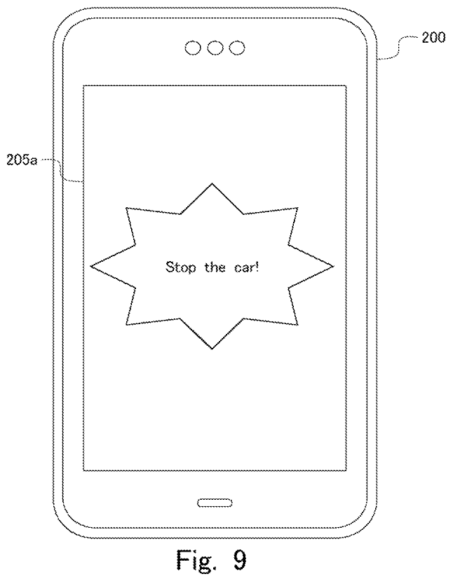

When the second command is transmitted from the on-board device 100 to the mobile terminal 200, the second notification is output at the mobile terminal 200 that the driver of the vehicle 10 is operating or looking at. FIG. 9 is a diagram illustrating an example of the second notification that is output at the mobile terminal 200. In FIG. 9, a message “Stop the car!” is displayed as the second notification, on the touch panel display 205a included in the input/output I/F 205 of the mobile terminal 200. Additionally, the second notification may be a mark for notifying of approach to another vehicle that is present ahead, for example. Moreover, the second notification is displayed preferentially to an image on the mobile terminal 200 that the driver of the vehicle 10 is operating or looking at.

When the second notification is output at the mobile terminal 200 in the manner described above, the driver who is operating or looking at the mobile terminal 200 may be made to notice that the subject vehicle 10 is moving close to another vehicle. As a result, the subject vehicle 10 may be urged to stop. Accordingly, the subject vehicle 10 may be prevented from coming very close to another vehicle existing ahead of the subject vehicle 10 after the subject vehicle 10 starts moving due to switching of the display of the traffic light from the red signal to the green signal.

(Flow of Information Processing)

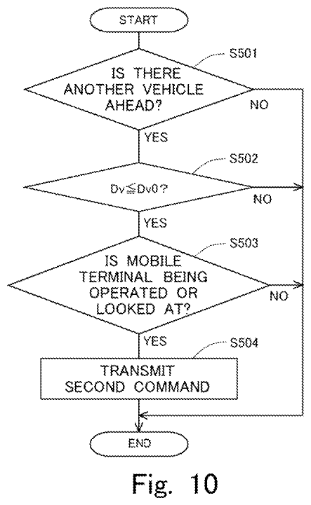

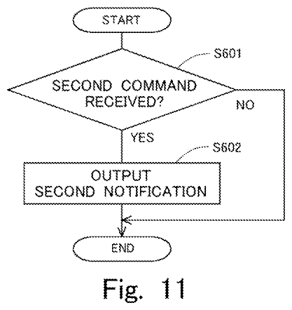

In the following, a flow of information processing that is performed by each of the on-board device 100 and the mobile terminal 200 of the monitoring system 1 according to the present embodiment will be described with reference to FIGS. 10 and 11. FIG. 10 is a flowchart illustrating the flow of information processing that is performed by the controller 110 of the on-board device 100. FIG. 11 is a flowchart illustrating the flow of information processing that is performed by the controller 210 of the mobile terminal 200 inside the vehicle 10.

Additionally, the processes illustrated in FIGS. 10 and 11 are repeatedly performed after the subject vehicle 10 starts moving due to switching of the display of the traffic light from the red signal to the green signal. Furthermore, a period of time when the processes are repeatedly performed may be a period of time from when the subject vehicle 10 starts moving to when the traveling speed of the subject vehicle 10 reaches a predetermined speed, for example. The mobile terminal 200 may repeat the processes illustrated in FIG. 11 while the predetermined application for using the monitoring system 1 is active.

In the flow illustrated in FIG. 10, first, in S501, whether there is another vehicle ahead of the subject vehicle 10 is determined from an image that is acquired from the vehicle exterior camera 11. In the case where there is no other vehicle, a negative determination is made in S501, and execution of the present flow is temporarily ended. In the case where a positive determination is made in S501, or in other words, in the case where another vehicle that is present ahead of the subject vehicle 10 is detected, the process in S502 is performed next.

In S502, whether a distance Dv between the other vehicle that is detected in S501 and the subject vehicle 10 is equal to or smaller than a predetermined distance Dv0 is determined. For example, the distance Dv between the other vehicle and the subject vehicle 10 may be determined based on an image that is acquired from the vehicle exterior camera 11. Furthermore, in a case where the vehicle 10 includes a sensor for detecting a distance to another vehicle that is present ahead, the distance Dv may be acquired from the sensor. Moreover, the predetermined distance Dv0 may be a distance that is determined in advance as a distance at which the driver is urged to stop the subject vehicle 10. If the distance Dv between the other vehicle and the subject vehicle 10 is greater than the predetermined distance Dv0, a negative determination is made in S502, and execution of the present flow is temporarily ended. In the case where a positive determination is made in S502, or in other words, in the case where the distance Dv between the other vehicle and the subject vehicle 10 is equal to or smaller than the predetermined distance Dv0, the process in S503 is performed next.

In S503, whether the driver of the vehicle 10 is operating or looking at the mobile terminal 200 that the driver is carrying is determined based on an image that is acquired from the vehicle interior camera 12. Additionally, also in S503, whether the driver of the vehicle 10 is operating or looking at the mobile terminal 200 may be determined by the same method as in the example modification 2 of the first embodiment described above. If the driver of the vehicle 10 is not operating or looking at the mobile terminal 200, a negative determination is made in S503. In this case, execution of the present flow is temporarily ended. That is, in this case, the second command is not transmitted to the mobile terminal 200. In the case where a positive determination is made in S503, or in other words, in the case where the driver of the vehicle 10 is operating or looking at the mobile terminal 200, the process in S504 is performed next. In S504, the second command is transmitted to the mobile terminal 200 using the near-field communication unit 120.

Moreover, in the flow illustrated in FIG. 11, first, in S601, whether the second command is received from the on-board device 100 by the near-field communication unit 220 is determined. If the second command is not transmitted by the on-board device 100, the second command is not received by the mobile terminal 200, and a negative determination is made in S601. If the second command is transmitted by the on-board device 100, the second command is received by the mobile terminal 200. In this case, a positive determination is made in S601, and the process in S602 is performed next. In S602, the second notification is output using the input/output unit 230. The driver who is operating or looking at the mobile terminal 200 may thus be urged to stop the subject vehicle 10.

### Example Modification

Additionally, also with the monitoring system 1 according to the present embodiment, that the driver of the vehicle 10 is operating or looking at the mobile terminal 200 does not necessarily have to be detected by the on-board device 100. That is, when the distance Dv between another vehicle and the subject vehicle 10 is equal to or smaller than the predetermined distance Dv0, the on-board device 100 may transmit the second command to the mobile terminal 200 without determining whether the driver of the vehicle 10 is operating or looking at the mobile terminal 200. Additionally, the flow of information processing that is performed by the controller 110 of the on-board device 100 at this time is the flow illustrated in FIG. 10 without S503.

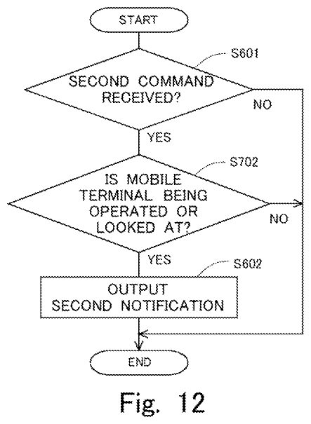

In the present example modification, the mobile terminal 200 may determine whether the driver of the vehicle 10 is operating or looking at the mobile terminal 200, when the second command is received. Now, a flow of information processing that is performed by the mobile terminal 200 in the present example modification will be described with reference to FIG. 12. FIG. 12 is a flowchart illustrating a flow of information processing that is performed by the controller 210 of the mobile terminal 200 inside the vehicle 10. Additionally, processes performed in S601 and S602 in the flow illustrated in FIG. 12 are the same as the processes performed in S601 and S602 in the flow illustrated in FIG. 11, and a description thereof will be omitted.

In the flow illustrated in FIG. 12, in the case where a positive determination is made in S601, the process in S702 is performed next. In S702, whether the driver of the vehicle 10 is operating or looking at the mobile terminal 200 is determined. If the driver of the vehicle 10 is not operating or looking at the mobile terminal 200, a negative determination is made in S702. In this case, execution of the present flow is temporarily ended. That is, in this case, the second notification is not output at the mobile terminal 200. In the case where a positive determination is made in S702, or in other words, in the case where the driver of the vehicle 10 is operating or looking at the mobile terminal 200, the process in S602 is performed next.

Also by the flow as described above, if the driver of the subject vehicle 10 is operating or looking at the mobile terminal 200 when the distance Dv between another vehicle and the subject vehicle 10 falls to or below the predetermined distance Dv0 after the subject vehicle 10 starts moving due to switching of the display of the traffic light from the red signal to the green signal, the second notification is output at the mobile terminal 200.

### Fourth Embodiment

(Outline of System)

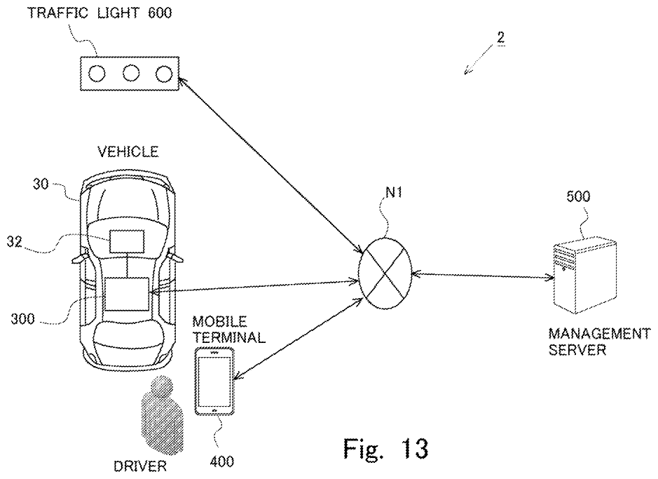

FIG. 13 is a diagram illustrating a schematic configuration of a monitoring system according to a present embodiment. A monitoring system 2 includes an on-board device 300 and a vehicle interior camera 32 that are mounted on a vehicle 30, a mobile terminal 400 that is carried by a driver of the vehicle 30, a traffic light 600, and a management server 500. In the monitoring system 2, the on-board device 300, the mobile terminal 400, and the traffic light 600 are connected to the management server 500 over a network N1. As the network N1, a wide area network (WAN), which is a worldwide public communication network such as the Internet, or a mobile communication network for mobile phones may be adopted, for example.

Like the on-board device 100 of the monitoring system 1 illustrated in FIG. 1, the on-board device 300 includes a computer including a processor, a main storage unit, an auxiliary storage unit, a near-field communication interface, and an in-vehicle communication interface. At the vehicle 30, the vehicle interior camera 32 is connected to the on-board device 300 over a predetermined in-vehicle network. Moreover, like the mobile terminal 200 of the monitoring system 1 illustrated in FIG. 1, the mobile terminal 400 includes a computer including a processor, a main storage unit, an auxiliary storage unit, a near-field communication interface, and an input/output interface. Moreover, the computer configuring the on-board device 300 and the computer configuring the mobile terminal 400 each further include a communication interface for connecting the on-board device 300 or the mobile terminal 400 to the network N1. For example, the communication interface connects the on-board device 300 or the mobile terminal 400 to the network N1 using a predetermined wireless communication standard such as 3rd Generation (3G) or Long Term Evolution (LTE).

The management server 500 is a server device that is provided outside the vehicle 30, and includes a general computer. The computer configuring the management server 500 includes a processor, a main storage unit, an auxiliary storage unit, and a communication interface for connecting the management server 500 to the network N1. Moreover, in the monitoring system 2, the processes performed by the on-board device 100 of the monitoring system 1 according to the first to third embodiments described above are performed by the management server 500.

(Functional Configuration)

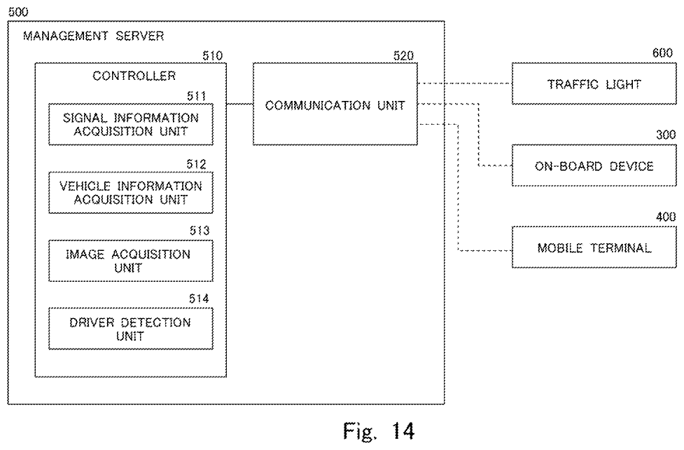

In the following, a functional configuration of the management server 500 configuring the monitoring system 2 according to the present embodiment will be described with reference to FIG. 14. FIG. 14 is a block diagram schematically illustrating an example of a functional configuration of the management server 500.

The management server 500 includes a controller 510 and a communication unit 520. The communication unit 520 includes a function of connecting the management server 500 to the network N1. The communication unit 520 is implemented by the communication interface of the computer configuring the management server 500. The controller 510 includes a function of performing arithmetic processing to control the management server 500. The controller 510 may be implemented by the processor of the computer configuring the management server 500.

The controller 510 performs, using the communication unit 520, a process of transmitting/receiving various information pieces to/from each of the traffic light 600, the on-board device 300, and the mobile terminal 400. Specifically, the controller 510 receives, from the traffic light 600, position information of the traffic light 600 and display information indicating the signal that the traffic light 600 is displaying. Furthermore, the controller 510 receives position information of the vehicle 30 from the on-board device 300. Moreover, the controller 510 acquires position information of other vehicles (vehicles other than the vehicle 30) from on-board devices mounted on such other vehicles. Moreover, at the vehicle 30, an image of a vehicle interior that is captured by the vehicle interior camera 32 is transmitted to the on-board device 300 over the in-vehicle network. Then, the controller 510 receives the image that is captured by the vehicle interior camera 32 from the on-board device 300. Furthermore, as described later, the controller 510 transmits the first command and the second command to the mobile terminal 400.

Moreover, the controller 510 includes a signal information acquisition unit 511, a vehicle information acquisition unit 512, an image acquisition unit 513, and a driver detection unit 514. The signal information acquisition unit 511 includes a function of acquiring the position information and the display information of the traffic light 600 that are received from the traffic light 600. The vehicle information acquisition unit 512 includes a function of acquiring the position information of the vehicle 30 that is received from the on-board device 300, and the position information of another vehicle that is received from the on-board device of such other vehicle. The image acquisition unit 513 includes a function of acquiring an image of the vehicle interior of the vehicle 30 that is received from the on-board device 300. The driver detection unit 514 includes a function of detecting a driver of the vehicle 30 by performing predetermined image processing on the image of the vehicle interior of the vehicle 30 that is acquired by the image acquisition unit 513. Furthermore, the driver detection unit 514 determines whether the driver of the vehicle 30 who is detected is operating or looking at the mobile terminal 400 that the driver is carrying.

Moreover, the controller 510 detects that the vehicle 30 is stopped before the traffic light 600, based on the position information of the traffic light 600 and the position information of the vehicle 30. Furthermore, when the vehicle 30 is stopped before the traffic light 600, the controller 510 detects switching of display of the traffic light 600 from the red signal to the green signal, based on the display information of the traffic light 600.

Furthermore, when switching of the display of the traffic light 600 from the red signal to the green signal is detected, the controller 510 determines whether the driver of the vehicle 30 is operating or looking at the mobile terminal 400. Then, in the case where the driver of the vehicle 30 is determined to be operating or looking at the mobile terminal 400, the controller 510 transmits the first command to the mobile terminal 400. As a result, the first notification is output at the mobile terminal 400 that the driver of the vehicle 30 is operating or looking at.

Additionally, the controller 510 is capable of detecting that another vehicle is stopped before the traffic light 600 and ahead of the subject vehicle 30, based on the position information of such other vehicle. Accordingly, also in the present embodiment, as in the second embodiment, in the case where another vehicle that is present ahead of the subject vehicle 30 is stopped, the first command may be transmitted to the mobile terminal 400 after such other vehicle starts moving after the display of the traffic light 600 is switched from the red signal to the green signal.

Furthermore, after the display of the traffic light 600 is switched from the red signal to the green signal, the controller 510 detects that the vehicle 30 started moving, based on the position information of the vehicle 30. Moreover, after the subject vehicle 30 starts moving, the controller 510 determines whether the distance between another vehicle that is present ahead of the subject vehicle 30 and the subject vehicle 30 is equal to or smaller than the predetermined distance, based on the position information of the subject vehicle 30 and the position information of such other vehicle.

Furthermore, in the case where the distance between such other vehicle and the subject vehicle 30 is determined to be equal to or smaller than the predetermined distance, the controller 510 determines whether the driver of the subject vehicle 30 is operating or looking at the mobile terminal 400. In the case where the driver of the vehicle 30 is determined to be operating or looking at the mobile terminal 400, the controller 510 transmits the second command to the mobile terminal 400. As a result, the second notification is output at the mobile terminal 400 that the driver of the vehicle 30 is operating or looking at.

Additionally, also with the monitoring system 2 according to the present embodiment, that the driver of the vehicle 30 is operating or looking at the mobile terminal 400 does not necessarily have to be detected by the management server 500. That is, as in the example modification 3 of the first embodiment or the example modification of the third embodiment, whether the driver of the vehicle 30 is operating or looking at the mobile terminal 400 may be determined by the mobile terminal 400. In this case, the first notification is output in the case where the driver of the vehicle 30 is determined by the mobile terminal 400 to be operating or looking at the mobile terminal 400 when the first command that is transmitted from the management server 500 is received. Furthermore, the second notification is output in the case where the driver of the vehicle 30 is determined by the mobile terminal 400 to be operating or looking at the mobile terminal 400 when the second command that is transmitted from the management server 500 is received.

### Other Embodiments

The embodiments described above are merely examples, and the present disclosure may be changed as appropriate within the scope of the disclosure. Furthermore, the processes and means described in the present disclosure may be freely combined to the extent that no technical conflict occurs.

Furthermore, a process that is described to be performed by one device may be shared and performed by a plurality of devices. Alternatively, processes described to be performed by different devices may be performed by one device. Which function is to be implemented by which hardware configuration (server configuration) in a computer system may be flexibly changed.

The present disclosure may also be implemented by supplying computer programs for implementing the functions described in the above embodiments to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions such as read-only memories (ROMs), random access memories (RAMs), EPROMs, EEPROMs, magnetic cards, flash memories, and optical cards.

What is claimed is:

1. An information processing device comprising a controller configured to:
detect that display of a traffic light is switched from a first signal instructing a vehicle to stop to a second signal allowing the vehicle to proceed, and
transmit a first command to a mobile terminal carried by a driver of a first vehicle that is stopped before the traffic light, when the display of the traffic light is switched from the first signal to the second signal, the first command instructing that a first notification for urging the driver to start moving the first vehicle be output.

2. The information processing device according to claim 1, wherein
the controller is further configured to determine whether the driver is operating or looking at the mobile terminal, when the display of the traffic light is switched from the first signal to the second signal, and
the controller does not transmit the first command to the mobile terminal when the driver is not operating or looking at the mobile terminal.

3. The information processing device according to claim 1, wherein, in a case where an other vehicle is stopped before the traffic light and ahead of the first vehicle, the controller transmits the first command to the mobile terminal after the other vehicle starts moving, when the display of the traffic light is switched from the first signal to the second signal.

4. The information processing device according to claim 1, wherein the controller is further configured to transmit, to the mobile terminal, a second command instructing that a second notification for urging the driver to stop the first vehicle be output, in a case where a distance between an other vehicle that is present ahead of the first vehicle and the first vehicle falls to or below a predetermined distance after the display of the traffic light is switched from the first signal to the second signal and the first vehicle starts moving.

5. The information processing device according to claim 4, wherein
the controller is further configured to determine whether the driver is operating or looking at the mobile terminal, when the distance between the other vehicle and the first vehicle falls to or below the predetermined distance, and
the controller does not transmit the second command to the mobile terminal when the driver is not operating or looking at the mobile terminal.

6. The information processing device according to claim 1, wherein the controller detects that the display of the traffic light is switched from the first signal to the second signal, based on an image that is captured by a vehicle exterior camera that is provided on the first vehicle and that captures a surrounding state of the first vehicle.

7. The information processing device according to claim 1, wherein the controller detects that the display of the traffic light is switched from the first signal to the second signal, based on display information indicating a signal that is being displayed by the traffic light, the display information being transmitted from the traffic light.

8. The information processing device according to claim 2, wherein the controller determines whether the driver is operating or looking at the mobile terminal, based on an image that is captured by a vehicle interior camera that is provided on the first vehicle and that captures a state of a vehicle interior of the first vehicle.

9. The information processing device according to claim 2, wherein the controller determines whether the driver is operating or looking at the mobile terminal, based on terminal information indicating that the mobile terminal is being operated or is being looked at, the terminal information being transmitted from the mobile terminal.

10. The information processing device according to claim 1, wherein the information processing device is an on-board device that is mounted on the first vehicle and that is capable of communicating with the mobile terminal through near-field wireless communication.

11. The information processing device according to claim 1, wherein the information processing device is a server device that is provided outside the first vehicle and that is capable of communicating with the mobile terminal over a network.

12. A non-transitory storage medium storing a program that is executed by a computer that controls a mobile terminal, wherein the program causes the mobile terminal to:
receive a first command from an information processing device that, when display of a traffic light is switched from a first signal instructing a vehicle to stop to a second signal allowing the vehicle to proceed, transmits the first command to the mobile terminal carried by a driver of a first vehicle that is stopped before the traffic light, the first command instructing that a first notification for urging the driver to start moving the first vehicle be output, and
output the first notification when the first command is received.

13. The non-transitory storage medium according to claim 12, wherein
the program further causes the mobile terminal to determine whether the driver is operating or looking at the mobile terminal, when the first command is received, and
the program causes the mobile terminal to not output the first notification, when the driver is not operating or looking at the mobile terminal, and causes the mobile terminal to output the first notification, when the driver is operating or looking at the mobile terminal.

14. The non-transitory storage medium according to claim 12, wherein
the information processing device transmits, to the mobile terminal, a second command instructing that a second notification for urging the driver to stop the first vehicle be output, in a case where a distance between an other vehicle that is present ahead of the first vehicle and the first vehicle falls to or below a predetermined distance after the display of the traffic light is switched from the first signal to the second signal and the first vehicle starts moving, and
the program further causes the mobile terminal to:
receive the second command from the information processing device, and
output the second notification when the second command is received.

15. The non-transitory storage medium according to claim 14, wherein
the program further causes the mobile terminal to determine whether the driver is operating or looking at the mobile terminal, when the second command is received, and
the program causes the mobile terminal to not output the second notification, when the driver is not operating or looking at the mobile terminal, and causes the mobile terminal to output the second notification, when the driver is operating or looking at the mobile terminal.

16. An information processing method that is performed by a computer, the method comprising:
detecting that display of a traffic light is switched from a first signal instructing a vehicle to stop to a second signal allowing the vehicle to proceed; and
transmitting a first command to a mobile terminal carried by a driver of a first vehicle that is stopped before the traffic light, when the display of the traffic light is switched from the first signal to the second signal, the first command instructing that a first notification for urging the driver to start moving the first vehicle be output.

17. The information processing method according to claim 16, further comprising determining whether the driver is operating or looking at the mobile terminal, when the display of the traffic light is switched from the first signal to the second signal, wherein
the first command is not transmitted to the mobile terminal when the driver is not operating or looking at the mobile terminal.

18. The information processing method according to claim 16, wherein, in a case where an other vehicle is stopped before the traffic light and ahead of the first vehicle, the first command is transmitted to the mobile terminal after the other vehicle starts moving, when the display of the traffic light is switched from the first signal to the second signal.

19. The information processing method according to claim 16, further comprising transmitting, to the mobile terminal, a second command instructing that a second notification for urging the driver to stop the first vehicle be output, in a case where a distance between an other vehicle that is present ahead of the first vehicle and the first vehicle falls to or below a predetermined distance after the display of the traffic light is switched from the first signal to the second signal and the first vehicle starts moving.

20. The information processing method according to claim 19, further comprising determining whether the driver is operating or looking at the mobile terminal, when the distance between the other vehicle and the first vehicle falls to or below the predetermined distance, wherein the second command is not transmitted to the mobile terminal when the driver is not operating or looking at the mobile terminal.
